(19) United States
(12) Patent Application Publication
(10) Pub. No.: US 2007/0132800 A1
(43) Pub. Date: Jun. 14, 2007

(54) Methods of and apparatus for handling data associated with a cartridge

(76) Inventors: Jincheng Huang, Lexington, KY (US); Xuan-Chao Huang, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/301,134

(22) Filed: Dec. 12, 2005

(51) Int. Cl. B41J 29/393

(52) U.S. Cl. 347/19

(57) ABSTRACT

Methods of and apparatus for handling data associated with a cartridge for printing with the cartridge, such as those involving comparing color data associated with a cartridge with reference cartridge data representative of a type of the cartridge to yield a comparison result; and determining whether any of the color data is corrupt color data based on the comparison result.

### BACKGROUND OF THE INVENTION

1. Field of the invention

The present invention relates to imaging, and, more particularly, to a method of handling data associated with a cartridge.

2. Description of the related art

In recent years, the use of imaging apparatuses, such as printers, for home and business purposes has increased significantly. Such printers typically employ one or more cartridges that supply colorant used for printing, such as color ink jet cartridges and/or ink tanks, and color electrophotographic cartridges. Users frequently obtain or create images, including scanned images, photos downloaded from the internet, or from a digital camera, as well as images created or modified by the user with various application software products that are available to businesses and consumers alike. The users often wish to reproduce such images on the printer. However, the reproduced image may not satisfactorily represent the original image due to variations in the cartridges. In addition, the reproduced image may vary as between cartridges, for example, where a user desires to print a plurality of the same image, but needs to replace a cartridge prior to completion of the print job. The variation may be caused by the different color reproducing characteristics of the different cartridges.

Accordingly, color consistency is important for color printing. Since the inks manufactured or available in the market may vary significantly as between different cartridges, it is foreseen that in order to minimize color differences, measurements of the colorant properties may be made, and stored in a memory, for example, associated with each cartridge. The corresponding color data would then be used to correct the color output during printing.

However, the color data may be corrupted or damaged, for example, during the measuring process, when storing the data in the cartridge memory, or any adverse electromagnetic effect damaging the data that has been previously stored. Corrupted or damaged data may thus invalidate the purpose of using the data to make color correction.

### SUMMARY OF THE INVENTION

The invention, in one exemplary embodiment, relates to a method of handling data associated with a cartridge for printing with the cartridge. The method includes comparing color data associated with a cartridge with reference cartridge data representative of a type of the cartridge to yield a comparison result; and determining whether any of the color data is corrupt color data based on the comparison result.

The invention, in another exemplary embodiment, relates to an imaging apparatus that handles data associated with a cartridge for printing with the cartridge. The imaging apparatus includes a print engine configured to operatively receive the cartridge; and a controller communicatively coupled to the print engine. The controller executes instructions to determine whether any color data associated with the cartridge is corrupt color data based on comparing the color data with reference cartridge data representative of a type of the cartridge.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an embodiment of an imaging system.

FIG. 2 is a diagrammatic depiction of a colorspace converter accessing a color conversion lookup table in accordance with an embodiment of the present invention.

FIGS. 3A and 3B depict features of a color cube employed in accordance with an embodiment of the present invention.

FIG. 4 is a flowchart generally depicting a method of handling data associated with a cartridge for printing with the cartridge in accordance with an embodiment of the present invention.

FIG. 5 is a flowchart depicting methods for determining if color data is corrupt in accordance with the embodiment of FIG. 4.

FIG. 6 is a graphical representation of a portion of a color cube, depicting data points surrounding a corrupt color point in the form of a missing color point.

FIG. 7 is a graphical representation of how a missing color point may be estimated in order to correct corrupt color data.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF EXEMPLARY EMBODIMENTS OF TIE INVENTION

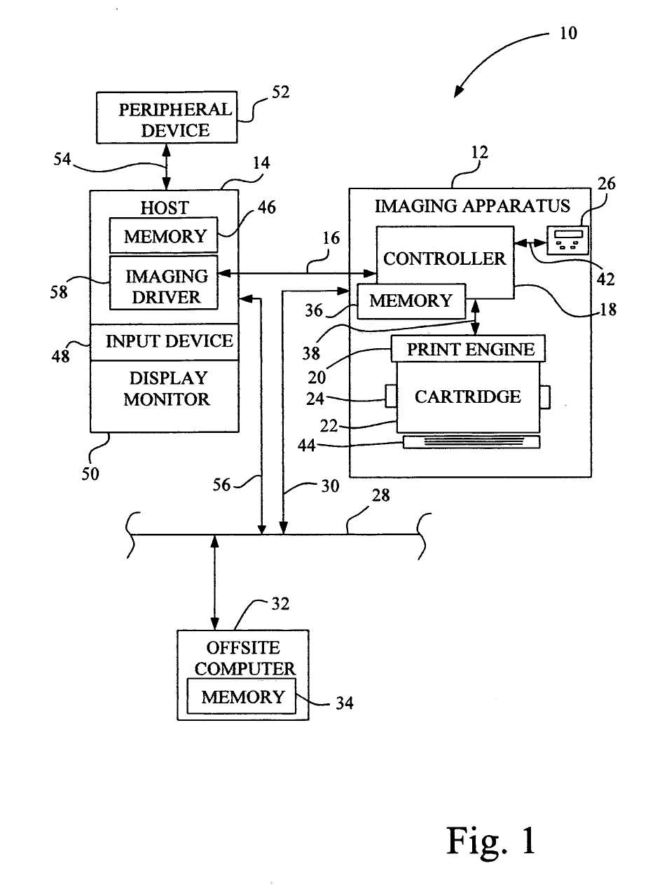

Referring now to the drawings, and particularly to FIG. 1, there is shown a diagrammatic depiction of an imaging system 10. In the embodiment depicted, imaging system 10 includes an imaging apparatus 12 and a host 14. Imaging apparatus 12 communicates with host 14 via a communications link 16. Alternatively, it is contemplated that imaging system 10 may be an imaging apparatus without a corresponding host computer, such as imaging apparatus 12 in the form of a stand-alone imaging apparatus, wherein the necessary functions of host 14 are performed by imaging apparatus 12 itself.

Imaging apparatus 12 may be, for example, an ink jet printer and/or copier, an electrophotographic printer and/or copier, or an all-in-one (AIO) unit that includes a printer, a scanner, and possibly a fax unit. Imaging apparatus 12 includes a controller 18, a print engine 20, one or more printing cartridges, such as a cartridge 22 having a cartridge memory 24, and a user interface 26. Controller 18 is communicatively coupled to print engine 20. Print engine 20 is configured to operatively receive cartridge 22, as well as to provide a communicative interface between controller 18 and cartridge memory 24. Imaging apparatus 12 has access to a network 28, for example, such as the Internet, via a communication line 30, and is capable of interfacing with other systems, such as an offsite computer 32 having an offsite memory 34, in order to transmit and/or receive data for use in carrying out its imaging functions, updating software or firmware, and/or authenticating cartridge 22. Offsite computer 32 may be a network server operated by, for example, a manufacturer, distributor and/or retailer of cartridge 22, imaging apparatus 12, and/or imaging system 10.

Controller 18 includes a processor unit and an associated memory 36, and may be formed as one or more Application Specific Integrated Circuits (ASIC). Controller 18 may be a printer controller, a scanner controller, or may be a combined printer and scanner controller. Although controller 18 is depicted in imaging apparatus 12, alternatively, it is contemplated that all or a portion of controller 18 may reside in host 14. Controller 18 communicates with print engine 20, cartridge 22, and cartridge memory 24, via a communications link 38, and with user interface 26 via a communications link 42. Controller 18 serves to process print data, to operate print engine 20 during printing, and to perform color correction.

In the context of the examples for imaging apparatus 12 given above, print engine 20 may be, for example, a color ink jet print engine or a color electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 to eject ink droplets onto substrate 44 in order to reproduce text or images, etc. As an electrophotographic print engine, print engine 20 causes cartridge 22 to deposit toner onto substrate 44, which is then fused to substrate 44 by a fuser (not shown).

Host 14 may be, for example, a personal computer, including memory 46, an input device 48, such as a keyboard, and a display monitor 50. A peripheral device 52, such as a digital camera, is coupled to host 14 via a communication link 54. Host 14 further includes a processor, input/output (I/O) interfaces, and is connected to network 28 via a communication line 56, and hence, has access to offsite computer 32, including offsite memory 34. Memory 46 may be any or all of RAM, ROM, NVRAM, or any available type of computer memory, and may include one or more of a mass data storage device, such as a floppy drive, a hard drive, a CD and/or a DVD unit or other optical storage devices.

During operation, host 14 includes in its memory 46 a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12. Nonetheless, imaging driver 58 is considered to be a part of imaging apparatus 12.

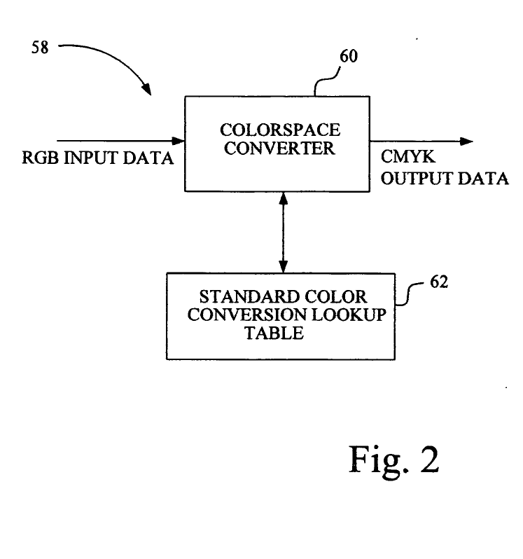

Referring now to FIG. 2, imaging driver 58 includes a colorspace converter 60. Although described herein as residing in imaging driver 58, colorspace converter 60 may be in the form of firmware or software, and may reside in either imaging driver 58 or controller 18. Alternatively, some portions of colorspace converter 60 may reside in imaging driver 58, while other portions reside in controller 18.

Colorspace converter 60 is used for converting color signals from a first colorspace, such as an RGB colorspace employed by display monitor 50 or a scanner, to a second colorspace, for example, CMYK (cyan, magenta, yellow, and black), which is used by print engine 20 for printing with cartridge 22. The output of colorspace converter 60 may be used to provide multilevel printing, for example, printing with more than one drop size and/or ink concentration for any or all of the CMYK colors.

The present embodiment is described with respect to CMYK printing, wherein, for example, cartridge 22 takes the form of two separate printhead cartridges; one for printing with CMY inks, and one for printing with black (K) ink. However, it shall be understood that the present invention is equally applicable to any number of colorants, as well as any number of colorant concentrations, or, for example, ink drop sizes, where the colorant is an ink. Colorants employed in accordance with the present invention may be inks, toners, or other color printing agents employed in performing color printing.

Coupled to colorspace converter 60 is a color conversion lookup table 62. Color conversion lookup table 62 is a multidimensional lookup table having at least three dimensions, and include RGB values and CMYK values, wherein each CMYK output value corresponds to an RGB input value. Color conversion lookup table 62 may also include other data, such as spectral data, or other values or parameters for use in performing color conversion or color correction. As shown in FIG. 2, for example, colorspace converter 60 converts input RGB color data for a displayed or scanned image into color shift corrected CMYK output data that may be printed by print engine 20 using color conversion lookup table 62.

Color conversion lookup table 62 incorporates color conversion data to support color conversion for multiple color formats and the multiple types of substrate 44. Color formats supported by color conversion lookup table 62, include, for example, monochrome K output using true black ink only, CMY color output, wherein neutral colors are formed using process black, also known as composite black, produced by using a combination of CMY color inks, and CMYK color printing using a combination of the CMY color inks and true black ink.

In an embodiment described herein, colorant data is arranged in color conversion lookup table 62 in an ordered format for access by colorspace converter 60 in performing color conversion for printing with imaging apparatus 12. Color conversion lookup table 62 may alternatively be in the form of groups of polynomial functions capable of providing the same multidimensional output as if in the form of lookup tables.

In order to perform color correction to compensate for the variation as between ink cartridges, the original colorant data of color conversion lookup table 62 is modified prior to being accessed by colorspace converter 60. In the present embodiment, the colorant data is modified based on data specific to a particular cartridge 22, as well as standardized reference data, both of which may be stored, for example, in cartridge memory 24.

For example, to collect color information for inks, color patches may be printed and measured so as to collect color data for the particular cartridge 22. In accordance with an embodiment of the present invention, a plurality of color patches are printed using each particular cartridge 22; the plurality of color patches are then measured to obtain color data associated with the particular cartridge 22 The color patches are generated by sampling in CMY color space. The patches are then measured, yielding a color space associated with the particular cartridge 22, which, in the present embodiment, takes the form of a color cube.

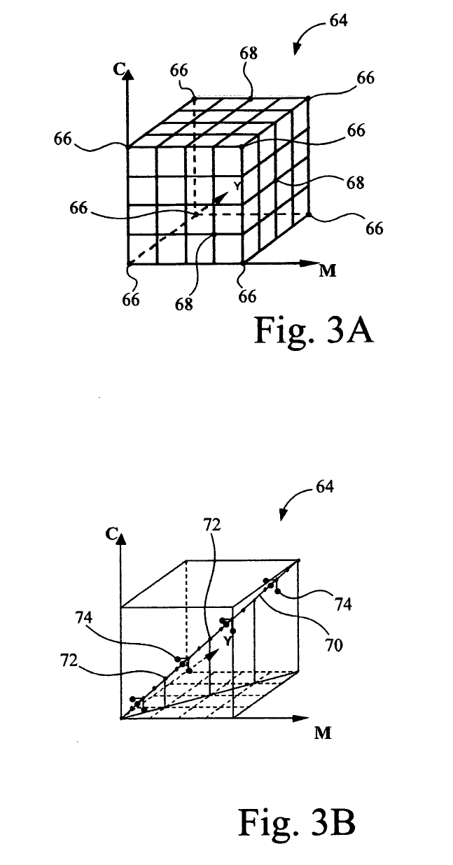

Referring now to FIGS. 3A and 3B, a 5×5×5 color cube 64, defined by the color space associated with the particular cartridge 22 is depicted. The primary axes of color cube 64 are labeled C, M, and Y, for the CMY inks. The grids of color cube 64 in CMY space are illustrated, wherein each point on the grid represents the color data pertaining to a corresponding color patch.

As seen in FIG. 3A, color cube 64 has eight vertex points 66 corresponding to the eight vertices of color cube 64, as well as a plurality of regular grid points 68 that are distributed throughout color cube 64.

As illustrated in FIG. 3B, color cube 64 includes a neutral axis 70. The neutral axis extends between the white point of color cube, where C=M=Y=0, and the black point, where C=M=Y=100% (e.g., a digital value of 255 for eight-bit color). Along the neutral axis, the colors are neutral, that is, the colors vary along a grayscale, and have essentially no chroma. Neutral axis 70 is defined by neutral points 72 corresponding to measured neutral color patches printed using the particular cartridge 22.

In addition to neutral points 72 are near-neutral points 74 adjacent to but not lying upon neutral axis 70. Near-neutral points 74 have small amounts of chroma, although they are visibly close to gray.

Note that for the sake of clarity, in the depictions of FIGS. 3A and 3B, only a few of regular grid points 68, neutral points 72 and near-neutral points 74 are accordingly labeled, whereas the actual number of those color points is based on the total number of color patches printed and measured. In the present exemplary embodiment, 149 sample points are used, which includes vertex points 66, regular grid points 68, 5 neutral points 72 inherent in a 5×5×5 grid and 12 additional neutral points 72 on neutral axis 70 for a total of 17 neutral points, and 12 near-neutral points 74 near located adjacent to neutral axis 70. Each CMY patch is measured in, for example, Lab color space (CIELAB), and the color data is stored in cartridge memory 24. Alternatively, it is contemplated that the color data is stored in memory 36, memory 46, or memory 34 for retrieval via network 28. This color data is used in order to perform color correction to correct for color shifts or variations as between different cartridges 22.

However, the color data may be corrupted or damaged, for example, during the measuring process, when storing the data in the cartridge memory, or any adverse electromagnetic effect damaging the data that has been previously stored. Corrupted or damaged data may thus invalidate the purpose of using the data to make color correction. The corrupted color data may be in the form of color points that are shifted and no longer valid, or may take the form of a missing data point, e.g., where the color data associated with the particular color point is missing, or, for example, reset to all logical ones or zeros. Since the color data for a cartridge generally has a regular structure, e.g., a known structure as between color points making up the color data, some of the corrupted data may be detected and corrected.

During ink cartridge manufacturing, the technique set forth in accordance with an exemplary embodiment of the present invention may be used not only detect and correct corrupted data automatically, but also to provide a warning, e.g., if number of corrupted data points exceeds some predetermined threshold, for example, five percent of color patches.

In an embodiment of the present invention, a normal cartridge or non-standard cartridge, e.g., a particular cartridge 22, is compared with standard cartridge reference data that is used to build color conversion lookup table 62. The standard cartridge reference data is reference cartridge data that represents the average cartridge 22, and is obtained, for example, by measuring the output of many cartridges 22, and obtaining statistical data therefrom. First, the difference (Dᵢ(c, m, y)) between the reference cartridge data and each individual cartridge 22 is computed for each patch. Each patch corresponds to a color point in both the color data and the reference cartridge data. Next, the mean (μ_{Di}(c, m, y)), the variance (σ_{Di}(c, m, y)), the minimum, and the maximum for each color point of the color data are determined. The color data includes a plurality of color points pertaining to the particular cartridge 22, and the reference cartridge data includes a plurality of reference color points corresponding thereto. From the color points and reference color points, a determination of whether any of the color data is corrupt may be made.

Notations used in describing embodiments of the present invention herein are set forth as follows:

| | |
|---|---|
| Mᵢ(c, m, y), i = L, a, b | Measured Value in |
| | L*a*b for Patch |
| | (color point; |
| | c, m, y) |
| SMᵢ(c, m, y), i = L, a, b | Measured Value in |
| | L*a*b for Patch |
| | (color point; |
| | c, m, y) for |
| | Standard Cartridge |
| | (reference cartridge |
| | data) |
| Dᵢ(c, m, y) = M, (c, m, y) − SMᵢ(c, m, y) | Difference |
| ${μ}_{Di} ( c , m , y ) = \frac{1}{N} {\sum }_{n} {D}_{i} ( c , m , y )$ | Mean of Difference |
| ${σ}_{Di}^{2} ( c , m , y ) = \frac{1}{N - 1} {\sum }_{n} {( {D}_{i} ( c , m , y ) - {μ}_{Di} ( c , m , y ) )}^{2}$ | Variance of Difference |

As set forth below, Table 1 shows a portion of the comparison between a cartridge and 27 other cartridges 22 in accordance with an embodiment of the present invention. In an exemplary embodiment, as previously indicated, the standard cartridge should represent the mean of all cartridges, i.e., the mean difference should be close to zero. The data used in Table 1 is a small subset of the total amount of color data obtained for each cartridge. In accordance with an embodiment of the present invention, the standard cartridge is used as a “true” representation of all cartridges 22 to establish trends for detecting and correcting corrupted data. As illustrated in Table 1, the values of the 27 cartridges 22 are within certain ranges with respect to the reference cartridge data that defines the standard cartridge.

TABLE 1
Comparison of Standard Cartridge and Other 27 Cartridges.

| Patch | Mean Difference | | | Variance | | | Minimum Difference | | | Maximum Difference | | |
|---|---|---|---|---|---|---|---|---|---|---|---|---|
| No. | L | a | b | L | a | b | L | a | b | L | a | b |
| 1 | 0.03 | −0.26 | 0.46 | 0.28 | 0.22 | 0.69 | −0.53 | −0.70 | −0.36 | 0.67 | 0.06 | 1.97 |
| 2 | 0.02 | 1.38 | −5.19 | 0.29 | 1.41 | 4.32 | −0.49 | −0.67 | −12.67 | 0.57 | 3.89 | 3.05 |
| 3 | 0.14 | 1.52 | −9.50 | 0.45 | 1.12 | 5.58 | −0.88 | −0.19 | −17.97 | 0.74 | 3.26 | 2.22 |
| 4 | 0.00 | 0.48 | −6.58 | 0.60 | 0.84 | 3.61 | −1.69 | −0.43 | −11.16 | 0.95 | 3.27 | 2.11 |
| 5 | −0.28 | 0.20 | −2.59 | 0.91 | 1.37 | 3.05 | −3.17 | −1.36 | −8.81 | 0.91 | 4.52 | 2.38 |
| 6 | 0.65 | −1.22 | 0.73 | 1.11 | 1.82 | 1.12 | −1.09 | −4.58 | −0.42 | 3.00 | 1.67 | 2.78 |
| 7 | 1.36 | −0.60 | −3.90 | 1.21 | 1.19 | 3.11 | −0.91 | −3.43 | −9.18 | 3.67 | 1.22 | 1.45 |
| 8 | 1.74 | −0.80 | −6.81 | 1.24 | 1.15 | 4.31 | −0.59 | −3.94 | −13.22 | 3.99 | 1.25 | 1.24 |
| . | . | . | . | . | . | . | . | . | . | . | . | . |
| . | . | . | . | . | . | . | . | . | . | . | . | . |
| . | . | . | . | . | . | . | . | . | . | . | . | . |
| 74 | 1.04 | 1.16 | −1.46 | 1.25 | 1.89 | 2.85 | −0.41 | −1.56 | −6.00 | 4.09 | 5.39 | 1.44 |
| 75 | 1.14 | 0.79 | −0.89 | 1.18 | 1.41 | 3.13 | −0.73 | −1.31 | −5.83 | 3.86 | 4.26 | 2.82 |
| 76 | 1.34 | −0.98 | 1.68 | 1.84 | 0.76 | 1.97 | −1.92 | −2.52 | −2.42 | 5.12 | 0.76 | 5.23 |
| 77 | 1.97 | 2.90 | −4.75 | 1.92 | 2.36 | 3.34 | −1.83 | −0.79 | −9.94 | 5.58 | 7.49 | 0.77 |
| 78 | 2.13 | 2.70 | −5.97 | 1.81 | 2.19 | 4.17 | −1.49 | −0.75 | −11.76 | 5.52 | 6.95 | 0.74 |
| 79 | 1.87 | 1.24 | −2.82 | 1.43 | 0.89 | 3.42 | −0.76 | −0.23 | −7.90 | 4.75 | 2.88 | 0.79 |
| 80 | 1.55 | −0.42 | 0.22 | 1.18 | 0.85 | 3.61 | 0.02 | −2.09 | −4.99 | 4.36 | 1.74 | 4.78 |
| . | . | . | . | . | . | . | . | . | . | . | . | . |
| . | . | . | . | . | . | . | . | . | . | . | . | . |
| . | . | . | . | . | . | . | . | . | . | . | . | . |
| 144 | 1.31 | 0.50 | −2.61 | 1.55 | 1.00 | 2.90 | −1.05 | −1.47 | −6.46 | 4.75 | 1.93 | 1.77 |
| 145 | 1.51 | 0.16 | −3.06 | 1.52 | 0.89 | 2.87 | −0.70 | −1.90 | −6.85 | 4.94 | 1.62 | 1.43 |
| 146 | 1.70 | 0.96 | −3.84 | 1.59 | 1.07 | 2.86 | −0.82 | −1.07 | −7.11 | 5.34 | 2.70 | 0.58 |
| 147 | 0.53 | 0.96 | −1.53 | 1.25 | 1.24 | 2.61 | −1.30 | −1.89 | −5.35 | 3.71 | 3.06 | 2.24 |
| 148 | 0.12 | −0.49 | −2.24 | 1.21 | 0.89 | 2.54 | −1.59 | −2.63 | −6.21 | 2.95 | 0.70 | 1.32 |
| 149 | 0.32 | −0.37 | −1.28 | 1.13 | 1.05 | 2.48 | −1.54 | −2.03 | −5.06 | 3.04 | 1.61 | 1.63 |
| Mean | 1.21 | 0.43 | −2.14 | 1.46 | 1.41 | 2.72 | −1.23 | −2.12 | −6.30 | 4.37 | 3.14 | 1.99 |
| STD | 0.76 | 1.25 | 2.16 | 0.38 | 0.57 | 0.91 | 0.73 | 1.58 | 3.08 | 1.34 | 2.13 | 1.59 |

Embodiments of the present invention may allow detection and correction of corrupted data, and in the present embodiment includes breaking up color cube 64 into a plurality of constituencies, each constituency pertaining to a group of color points that are each important to color correction in their own right. In the present exemplary embodiment, there are four constituencies: eight vertices, i.e., vertex points 66, 5×5×5 regular grid points 68, neutral points 72, and near-neutral points 74. As set forth below in a description of the present embodiment, each constituency is addressed separately.

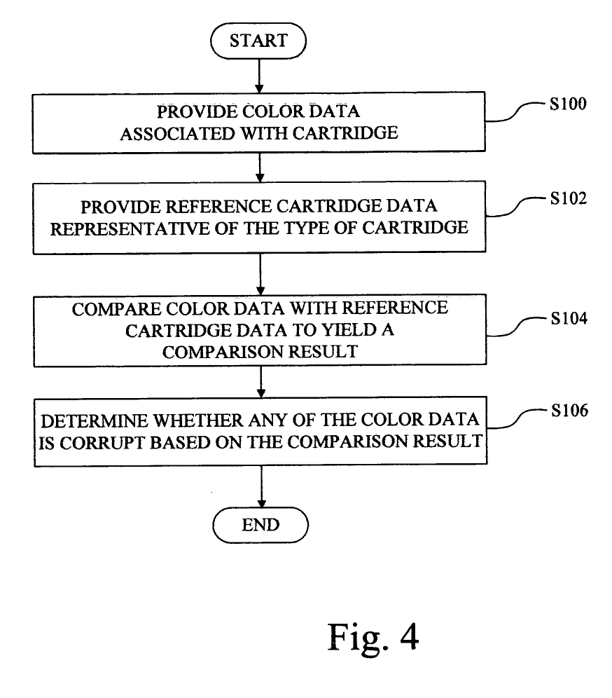

Referring now to FIG. 4, a method of handling data associated with a cartridge for printing with cartridge 22 is generally depicted in the form of a flowchart having steps S100 to S106. The process set forth below assumes that a particular cartridge 22 is intended for use in imaging apparatus 12, and that color data associated with the particular cartridge 22 has been generated, for example, by the manufacturer of the particular cartridge 22.

At step S100, color data associated with the particular cartridge 22 is provided to imaging apparatus 12.

In the present embodiment, the color data is stored in a memory accessible by imaging apparatus 12 into which cartridge 22 is installed, wherein memory is cartridge memory 24 associated with the particular cartridge 22. For example, the color data may be stored in cartridge memory 24 by the manufacturer of cartridge 22. Alternatively, it is contemplated that the color data may be stored in memory 34 of offsite computer 32 for retrieval via network 28. Other alternatives include wherein the color data is stored in either memory 36 or memory 46, for example, by virtue of a user of imaging apparatus 12 providing the color data via a removable media, such as a floppy disc, CD, memory card, and the like.

In the present embodiment, the stored color data is obtained by imaging apparatus 12, e.g., controller 18, for data handling operations, by virtue of imaging apparatus 12 reading the color data from cartridge memory 24.

At step S102, reference cartridge data representative of the type of the particular cartridge 22, for example, the cartridge model pertaining to the particular cartridge 22, is provided to imaging apparatus 12.

As with the color data, in the present embodiment, the reference cartridge data is stored in a memory accessible by imaging apparatus 12 into which cartridge 22 is installed, wherein memory is cartridge memory 24 associated with the particular cartridge 22. For example, the reference cartridge data may be stored in cartridge memory 24 by the manufacturer of cartridge 22. Alternatively, it is contemplated that the reference cartridge data may be stored in memory 34 of offsite computer 32 for retrieval via network 28. Other alternatives include wherein the reference cartridge data is stored in either memory 36 or memory 46, for example, by virtue of a user of imaging apparatus 12 providing the reference cartridge data via a removable media, such as a floppy disc, CD, memory card, and the like. As another alternative, the reference cartridge data may be stored as part of imaging driver 58 and/or controller 18.

In the present embodiment, the reference cartridge data is obtained by imaging apparatus 12, i.e., controller 18, for data handling operations, by virtue of imaging apparatus 12 reading the color data from cartridge memory 24.

At step S104, controller 18 compares the color data with the reference cartridge data to yield a comparison result.

At step S106, controller 18 determines whether any of the color data is corrupt color data based on the comparison result.

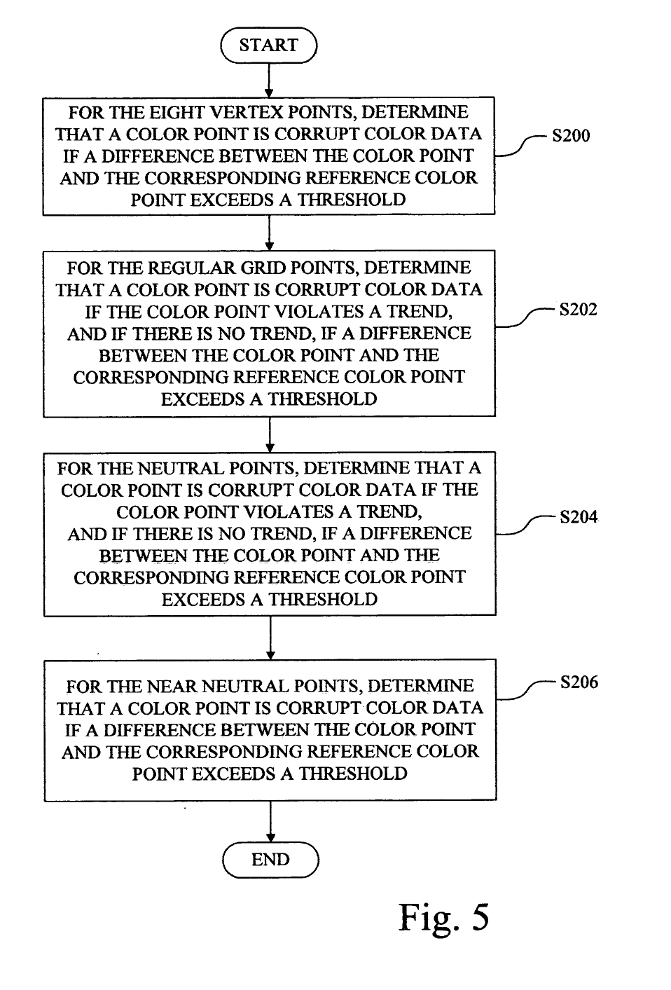

Referring now to FIG. 5 and steps S200 to S206, steps S104 and S106 are jointly described in greater detail below with respect to each constituency individually. For example, as set forth above, the color. space is divided into a plurality of constituencies, wherein the color data is compared with the reference data individually for each constituency of the plurality of constituencies, i.e., vertex points 66, regular grid points 68, neutral points 72, and near-neutral points 74.

At step S200, for the eight vertex points, controller 18 determines that a color point is corrupt color data if a difference between the color point and the corresponding reference color point exceeds a threshold.

For example, for the eight vertex points 66, the process of comparing color data with the reference cartridge data to yield the comparison result (S104) and determining whether any of the color data is corrupt color data based on the comparison result (S106) includes, for each selected color point of the plurality of color points, determining a difference between the selected color point and a corresponding reference color point of the plurality of reference color points, and determining if the difference exceeds a threshold, wherein the selected color point is determined to be corrupt color data if the difference exceeds the threshold.

There are eight color points that represent the eight vertex points in CMY color space. Table 2, set forth below, shows the mean difference, the variance, and the maximum absolute difference between various cartridges 22 and the reference cartridge data.

TABLE 2
Statistics Pertaining To Eight Vertex Points

| | | | | | | | | | | Maximum Absolute | | | | | |
|---|---|---|---|---|---|---|---|---|---|---|---|---|---|---|---|
| | | | | Mean Difference | | | Variance | | | Difference | | | Estimated Threshold | | |
| Index | C | M | Y | L | A | B | L | A | B | L | A | B | L | A | B |
| 1 | 0 | 0 | 0 | 0.03 | −0.26 | 0.46 | 0.32 | 0.24 | 0.68 | 0.67 | 0.70 | 1.97 | 0.98 | 0.99 | 2.49 |
| 2 | 0 | 0 | 4 | −0.28 | 0.20 | −2.59 | 0.90 | 1.36 | 3.05 | 3.17 | 4.52 | 8.81 | 2.98 | 4.27 | 11.73 |
| 3 | 0 | 4 | 0 | 0.35 | −0.21 | 0.00 | 1.33 | 0.77 | 1.52 | 3.31 | 2.09 | 3.21 | 4.34 | 2.53 | 4.57 |
| 4 | 0 | 4 | 4 | 0.22 | 0.04 | −1.15 | 1.13 | 1.29 | 2.36 | 3.13 | 2.78 | 6.02 | 3.60 | 3.91 | 8.22 |
| 5 | 4 | 0 | 0 | 0.65 | −1.46 | 1.03 | 1.48 | 1.49 | 1.16 | 4.04 | 4.90 | 4.49 | 5.10 | 5.93 | 4.50 |
| 6 | 4 | 0 | 4 | 0.67 | −0.49 | −1.24 | 1.19 | 1.16 | 2.97 | 3.65 | 3.92 | 5.72 | 4.23 | 3.96 | 10.15 |
| 7 | 4 | 4 | 0 | −0.15 | 0.58 | −0.86 | 1.23 | 0.72 | 1.35 | 2.88 | 1.93 | 3.47 | 3.85 | 2.74 | 4.90 |
| 8 | 4 | 4 | 4 | −0.73 | 0.28 | −1.80 | 1.65 | 1.00 | 2.95 | 5.01 | 2.33 | 6.58 | 5.67 | 3.28 | 10.66 |

To detect irregularity in the color data at the vertices, the current cartridge output, i.e., the particular cartridge 22 output, is compared with the reference cartridge data. If the difference is greater than a threshold, then the color point is determined to be corrupt color data.

The threshold for each data point may be determined as follows:
Tᵢ(c,m,y)=Max(|μ_{Di}+3×σ_{Di}|,|μ_{Di}−3×σ_{Di}|), i=l,a,b, (Equation 1)
where Max(.) is a maximum operation, and |x| is the absolute value of x. From Table 2, certain observations may be made, as follows: (1) The data fluctuation at (c=0, m=0, y=0) is much less than at the other points; (2) b is significantly larger when y=4 than y=0; and (3) L and a are not significantly different as between different vertex points 66.

Based on these observations, three sets of thresholds may be consolidated as follows:

$${T}_{1} = \{ {T}_{l} ( 0 , 0 , 0 ) , {T}_{a} ( 0 , 0 , 0 ) , {T}_{b} ( 0 , 0 , 0 ) \} , \\ for$$

$$c = 0 , m = 0 , y = 0$$

$${T}_{2} = \{ {MAX}_{c , m , y} {T}_{l} ( c , m , y ) , {MAX}_{c , m , y} {T}_{a} ( c , m , y ) , {MAX}_{c , m , y = 0} {T}_{b} ( c , m , 0 ) \} , \\ for$$

$$y = 0 , \\ {T}_{3} = \{ {MAX}_{c , m , y} {T}_{l} ( c , m , y ) , {MAX}_{c , m , y} {T}_{a} ( c , m , y ) , {MAX}_{c , m , y = 4} {T}_{b} ( c , m , 4 ) \} , \\ for$$

$$y = 4.$$

At step S202, for the regular grid points, controller 18 determines that a color is corrupt color data if the color point violates a trend, and if there is no trend, if difference between the color point and the corresponding reference color point exceeds a threshold.

For example, for the regular grid points 68, controller 18 determines whether is a trend pertaining to at least two reference color points, and determines if a selected color point corresponding to one of the at least two reference color points violates the trend (S104), wherein the selected color point is determined to be corrupt data if the selected color point violates the trend (S106). If there is no trend, a difference between the selected color point and a corresponding reference color point is determined (S104), and if the difference exceeds a threshold, the selected color is determined to be corrupt color data (S106), as set forth above with respect to S200.

Table 3, illustrated below, shows an alternate arrangement of the reference cartridge data. It is observed that there are some trends among L, a, and b, as follows: As increases, b increases; as m increases, L decreases and a increases; and as c increases, L decreases and b decreases.

TABLE 3
Alternate Arrangement of Reference Cartridge Data

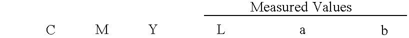

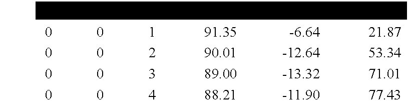

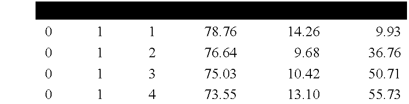

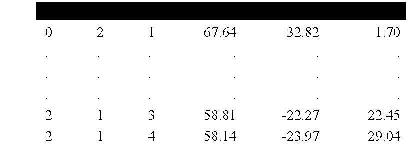

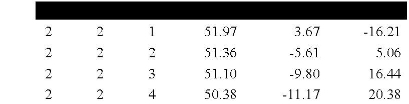

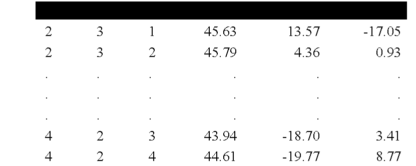

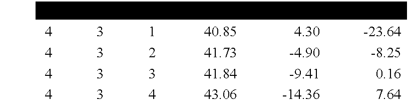

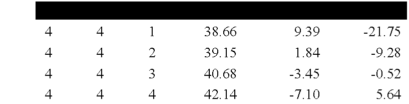

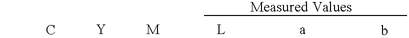

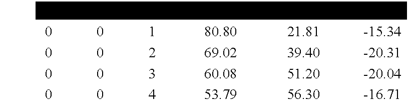

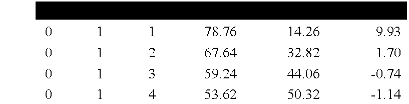

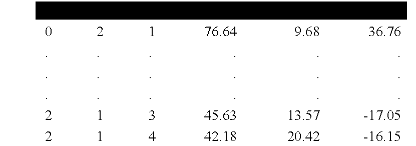

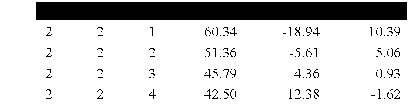

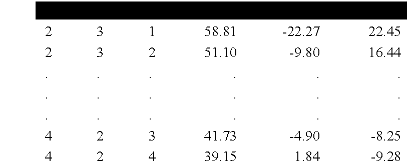

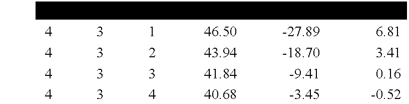

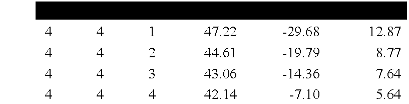

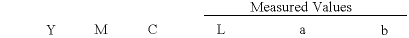

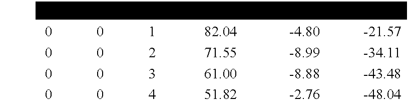

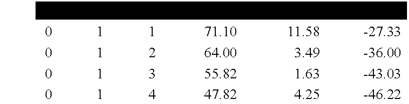

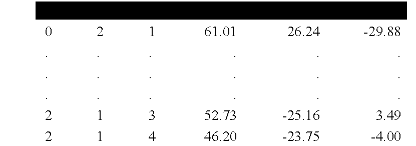

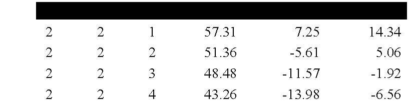

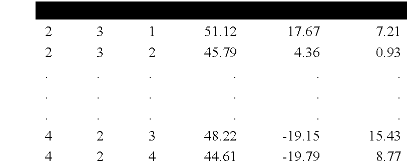

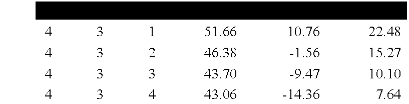

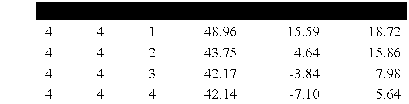

A simple piece-wise trend may be established by computing a piece-wise difference. By fixing two of the c, m, and y variables and varying the remaining one, a piece-wise difference may be defined as follows:
PDᵢ(c, m, y)=M(c, m, y)−M(c−1, m, y).

In the present example, m and y are fixed. It may be called piece-wise trend in c-direction. Table 4, set forth below, shows portion of the statistical data (mean, 10 variance, minimum, and maximum) pertaining to piece-wise differences for 27 cartridges.

TABLE 4
Piece-Wise Difference Statistical Data

| | Mean Difference | | | Variance | | | Minimum | | | Maximum | | |
|---|---|---|---|---|---|---|---|---|---|---|---|---|
| | L | a | b | L | a | b | L | a | b | L | a | b |
| 1 | 0.00 | 0.00 | 0.00 | 0.00 | 0.00 | 0.00 | 0.00 | 0.00 | 0.00 | 0.00 | 0.00 | 0.00 |
| 2 | −1.19 | −8.03 | 23.65 | 0.27 | 1.58 | 4.95 | −1.71 | −10.21 | 15.30 | −0.62 | −5.34 | 31.96 |
| 3 | −1.22 | −5.87 | 27.17 | 0.25 | 0.44 | 1.76 | −1.75 | −6.66 | 25.06 | −0.71 | −5.12 | 30.97 |
| 4 | −1.16 | −1.70 | 20.56 | 0.27 | 0.93 | 4.94 | −1.84 | −3.35 | 16.65 | −0.77 | −0.47 | 30.46 |
| 5 | −1.05 | 1.15 | 10.40 | 0.39 | 0.62 | 2.30 | −2.27 | 0.23 | 6.11 | −0.61 | 2.67 | 14.75 |
| 6 | 0.00 | 0.00 | 0.00 | 0.00 | 0.00 | 0.00 | 0.00 | 0.00 | 0.00 | 0.00 | 0.00 | 0.00 |
| 7 | −1.34 | −6.96 | 20.63 | 0.27 | 1.33 | 4.12 | −1.86 | −8.55 | 13.63 | −0.69 | −4.43 | 27.14 |
| 8 | −1.74 | −4.88 | 23.96 | 0.24 | 0.50 | 1.46 | −2.27 | −5.86 | 22.05 | −1.25 | −3.98 | 27.20 |
| 9 | −1.80 | −0.68 | 17.60 | 0.40 | 0.64 | 4.37 | −2.50 | 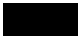 | 13.73 | −1.05 | 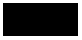 | 25.73 |
| 10 | −1.78 | 2.36 | 7.78 | 0.48 | 0.83 | 1.93 | −2.74 | 1.26 | 4.12 | −0.85 | 4.15 | 10.79 |
| . | . | . | . | . | . | . | . | . | . | . | . | . |
| . | . | . | . | . | . | . | . | . | . | . | . | . |
| . | . | . | . | . | . | . | . | . | . | . | . | . |
| 61 | 0.00 | 0.00 | 0.00 | 0.00 | 0.00 | 0.00 | 0.00 | 0.00 | 0.00 | 0.00 | 0.00 | 0.00 |
| 62 | −1.04 | −10.78 | 17.64 | 0.37 | 2.19 | 3.22 | −1.93 | −13.34 | 11.23 | −0.55 | −5.96 | 21.80 |
| 63 | −0.87 | −8.96 | 19.21 | 0.35 | 0.52 | 1.26 | −1.60 | −9.87 | 17.22 | −0.29 | −7.59 | 21.47 |
| 64 65 | −0.81 −0.74 | −5.28 −2.30 | 14.07 6.81 | 0.51 0.60 | 1.35 0.41 | 4.32 1.26 | 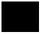 | −7.93 −3.00 | 10.81 4.41 | 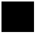 | −3.79 −1.42 | 22.43 9.44 |
| . | . | . | . | . | . | . | . | . | . | . | . | . |
| . | . | . | . | . | . | . | . | . | . | . | . | . |
| . | . | . | . | . | . | . | . | . | . | . | . | . |
| 121 | 0.00 | 0.00 | 0.00 | 0.00 | 0.00 | 0.00 | 0.00 | 0.00 | 0.00 | 0.00 | 0.00 | 0.00 |
| 122 123 124 125 | 0.28 0.51 1.07 0.98 | −7.97 −7.84 −5.99 −4.17 | 10.77 11.57 9.78 6.65 | 0.47 0.45 0.54 0.90 | 1.54 0.65 1.35 0.67 | 2.25 1.41 2.26 1.01 | 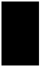 | −9.94 −9.21 −8.50 −5.73 | 6.80 9.46 7.74 5.18 | 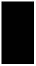 | −4.98 −6.74 −4.07 −3.11 | 13.85 14.47 14.22 8.44 |

If the signs for the minimum and the maximum for a given color point are the same, the color point is said to have a trend. Otherwise, the color point has no associated trend, such as the shaded color point data of Table 4. For the color points that are classified as “no trend”, two threshold values are determined, as follows:

$${T}_{4} = {Max}_{c , m , y} \vert SM ( c , m , y ) - SM ( c , m , y - 1 ) \vert , \\ for$$

$$c , m , y ∈ {}^{``} no {trend}^{″} , \\ {T}_{5} = {Max}_{c , m , y} \vert {μ}_{PD} ( c , m , y ) \pm 3 \times {σ}_{PD} ( c , m , y ) \vert , \\ for \\ c , m , y ∈ {}^{``} no {trend}^{″} ,$$

where μ_{PD} is the mean of piece-wise difference and σ_{PD} is the variance of piece-wise difference. In detecting corrupt color data, T₄ serves as threshold to determine those color points having “no trend” from standard cartridge. Based on the piece-wise differences for reference cartridge data, the trend of a color point may be classified as increasing, decreasing, or no trend. For those color points having a “trend”, a color point is determined to be corrupt color data if the trend is violated. For color points having “no trend”, they are determined to be corrupt if the magnitude of the piece-wise difference is greater than T₅.

In similar fashion, two sets of thresholds (T₆ and T₇, T₈ and T₉) are determined along the m-direction and the y-direction, respectively.

Once a color point is determined to be corrupt color data, the corrupt color data is corrected based on corresponding reference cartridge data. For example, a corrupt color point may be corrected using data pertaining to reference color points in 3 different directions.

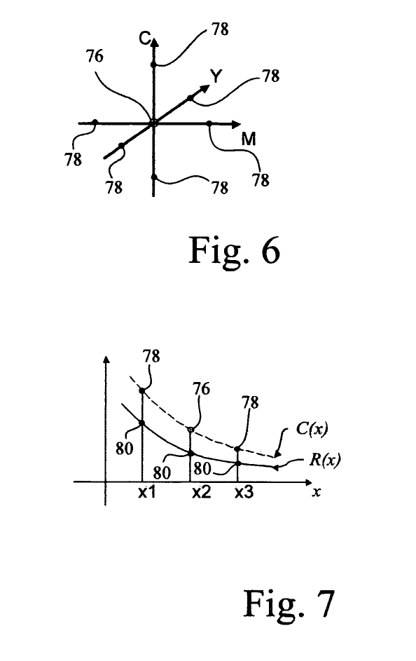

For example, referring now to FIG. 6, circle 76 represents the corrupted color data point for the particular cartridge 22, and solid dots 78 represent the valid color data points, i.e., uncorrupted color data for the particular cartridge 22. FIG. 6 illustrates the three directions of a missing data point, i.e., where the corruption of the color point data has resulted in the loss of that color point data.

Referring now to FIG. 7, a way to estimate the value for the corrupted color data is illustrated. R(x) pertains to reference cartridge data, and C(x) pertains to color data from the particular cartridge 22. Solid dots 78 represent the valid color data points, solid dots 80 represent reference cartridge data, and circle 76 represents the corrupted color data point for the particular cartridge 22. The corrupted color data point C(x₂) may be estimated as

$$\begin{matrix}C ( {x}_{2} ) = R ( {x}_{2} ) + \frac{( C ( {x}_{1} ) - R ( {x}_{1} ) ) + ( C ( {x}_{2} ) - R ( {x}_{2} ) )}{2} \\ = R ( {x}_{2} ) + \frac{( C ( {x}_{1} ) - C ( {x}_{2} ) ) + ( R ( {x}_{1} ) - R ( {x}_{2} ) )}{2} .\end{matrix}$$

For a given corrupted color data point, a value may be estimated from three different directions. For a better estimate, the fmal value may be the average value of the three.

Referring again to FIG. 5, at step S204, for the neutral points, controller 18 determines that a color point is corrupt color data if the color point violates a trend, and if there is no trend, if a difference between the color point and the corresponding reference color point exceeds a threshold.

For example, for the neutral points 72, controller 18 determines whether there is a trend pertaining to at least two reference color points, and determines if a selected color point corresponding to one of the at least two reference color points violates the trend (S104), wherein the selected color point is determined to be corrupt color data if the selected color point violates the trend (S106). If there is no trend, a difference between the selected color point and a corresponding reference color point is determined (S104), and if the difference exceeds a threshold the selected color point is determined to be corrupt color data (S106), as set forth above with respect to step S200.

As shown in FIG. 3B, the grid along the neutral axis is finer for high accuracy. Table 5, set forth below, shows the mean of difference, variance of difference, and maximum absolute difference as comparing 27 cartridges 22 with the reference cartridge data. From Table 5, it is observed that the color data values for the cartridges 22 are within certain ranges relative to the corresponding reference color points of the reference cartridge data. For each neutral point, the threshold may be estimateded using Equation 1. To reduce number of thresholds, some thresholds may be grouped, such as, T₁₀ for neutral point 1-2, T₁₁ for point 6-10, and T₁₂ for the rest.

TABLE 5
Comparison of Color Data With Reference Cartridge Data

| | | | | | | | Maximum Absolute | | | | | |
|---|---|---|---|---|---|---|---|---|---|---|---|---|
| | Mean Difference | | | Variance | | | Difference | | | Estimated Threshold | | |
| | L | a | b | | a | b | L | a | b | L | a | b |
| 1 | 0.03 | −0.26 | 0.46 | 0.28 | 0.22 | 0.71 | 0.67 | 0.70 | 1.97 | 0.89 | 0.91 | 2.59 |
| 2 | 0.42 | −0.03 | −0.68 | 0.53 | 0.25 | 0.78 | 1.56 | 0.49 | 2.05 | 2.02 | 0.78 | 3.01 |
| 3 | 1.58 | 1.01 | −1.48 | 1.21 | 0.83 | 1.45 | 3.68 | 2.40 | 3.42 | 5.20 | 3.51 | 5.82 |
| 4 | 1.94 | 1.16 | −2.60 | 1.56 | 1.30 | 2.40 | 4.68 | 3.83 | 6.32 | 6.62 | 5.06 | 9.81 |
| 5 | 1.81 | 0.81 | −3.04 | 1.82 | 1.48 | 2.92 | 4.96 | 3.66 | 7.91 | 7.28 | 5.26 | 11.82 |
| 6 | 2.35 | 1.76 | −3.60 | 2.05 | 1.84 | 3.28 | 6.02 | 5.66 | 8.45 | 8.49 | 7.27 | 13.43 |
| 7 | 2.62 | 1.89 | −3.91 | 2.15 | 1.70 | 3.27 | 6.42 | 5.12 | 8.31 | 9.06 | 6.99 | 13.72 |
| 8 | 2.41 | 1.49 | −3.71 | 2.17 | 1.93 | 3.50 | 6.29 | 5.37 | 8.28 | 8.93 | 7.29 | 14.21 |
| 9 | 2.38 | 1.62 | −4.76 | 2.20 | 1.72 | 3.44 | 6.29 | 5.45 | 9.40 | 8.98 | 6.77 | 15.08 |
| 10 | 2.04 | 1.52 | −3.53 | 1.73 | 1.33 | 3.20 | 5.48 | 4.36 | 6.97 | 7.23 | 5.50 | 13.14 |
| 11 | 1.59 | 1.16 | −3.23 | 1.46 | 0.98 | 2.80 | 4.70 | 3.03 | 7.42 | 5.98 | 4.09 | 11.62 |
| 12 | 0.99 | 0.52 | −2.33 | 1.32 | 0.94 | 3.08 | 4.10 | 2.01 | 7.00 | 4.97 | 3.34 | 11.58 |
| 13 | 0.70 | 0.52 | −2.26 | 1.22 | 0.96 | 3.10 | 3.78 | 2.30 | 6.61 | 4.37 | 3.39 | 11.57 |
| 14 | 0.22 | 0.33 | −1.27 | 1.26 | 0.95 | 2.67 | 3.16 | 2.02 | 4.95 | 4.01 | 3.17 | 9.29 |
| 15 | −0.28 | 0.52 | −1.51 | 1.26 | 1.12 | 2.72 | 2.53 | 2.46 | 5.19 | 4.07 | 3.89 | 9.67 |
| 16 | −1.15 | 0.17 | −1.32 | 1.33 | 1.01 | 2.76 | 3.91 | 2.11 | 5.59 | 5.14 | 3.21 | 9.60 |
| 17 | −0.73 | 0.28 | −1.80 | 1.67 | 1.04 | 3.01 | 5.01 | 2.33 | 6.58 | 5.76 | 3.39 | 10.84 |

Table 6 illustrates the results for the differences with previous neutral points in the same cartridge. As seen from the Table 6, L values decrease as c, m, and y increase up to a certain point and then fluctuate. There are no trends for a and b. The threshold for each point may be computed using Equation 1. Since the thresholds for a and b are not substantially different, one threshold may be used for each of a and b by taking the maximum of the calculated thresholds. One threshold for those L values that have no trend is used.

TABLE 6
Comparisons With Previous Neutral Points.

| | Mean | | | Variance | | | Minimum Difference | | | Maximum Difference | | | Threshold | | |
|---|---|---|---|---|---|---|---|---|---|---|---|---|---|---|---|
| | L | a | b | L | a | b | L | a | b | L | a | b | L | a | b |
| 1 | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |
| 2 | 4.95 | 0.02 | −0.12 | 0.60 | 0.27 | 1.35 | −6.02 | −0.46 | −2.56 | −3.87 | 0.42 | 1.54 | 6.76 | 0.83 | 4.18 |
| 3 | −6.52 | −0.88 | −0.35 | 0.74 | 0.79 | 0.73 | −7.95 | −1.99 | −1.26 | −5.42 | 0.56 | 0.88 | 8.73 | 3.24 | 2.53 |
| 4 | −5.65 | −1.23 | 0.80 | 0.41 | 0.57 | 1.05 | −6.31 | −1.92 | −1.26 | −4.78 | 0.13 | 2.28 | 6.87 | 2.94 | 3.95 |
| 5 | −4.40 | −0.17 | 1.11 | 0.49 | 0.55 | 0.75 | −5.42 | −0.98 | −0.33 | −3.50 | 0.96 | 2.35 | 5.87 | 1.82 | 3.35 |
| 6 | −6.91 | −2.63 | 1.04 | 0.55 | 0.73 | 0.76 | −6.85 | −4.18 | −0.62 | −4.92 | −0.72 | 2.45 | 7.57 | 4.81 | 3.31 |
| 7 | −4.46 | −1.15 | 1.39 | 0.33 | 0.43 | 0.45 | −5.26 | −2.08 | 0.20 | −3.78 | −0.31 | 2.07 | 5.44 | 2.43 | 2.76 |
| 8 | −3.83 | −1.15 | 2.17 | 0.33 | 0.50 | 0.54 | −4.67 | −2.08 | 1.27 | −3.24 | −0.28 | 3.36 | 4.81 | 2.64 | 3.79 |
| 9 | −3.09 | 0.41 | 1.21 | 0.45 | 0.69 | 0.52 | −3.98 | −0.62 | 0.20 | −2.28 | 1.95 | 2.30 | 4.44 | 2.48 | 2.79 |
| 10 | −3.64 | −1.95 | 1.31 | 0.65 | 0.75 | 0.71 | −4.94 | −3.27 | 0.34 | −2.58 | −0.78 | 2.95 | 5.60 | 4.20 | 3.45 |
| 11 | −2.36 | −0.72 | 0.63 | 0.47 | 0.88 | 1.08 | −3.34 | −2.38 | −0.73 | −1.44 | 0.80 | 2.82 | 3.78 | 3.37 | 3.86 |
| 12 | −1.74 | −0.39 | 0.90 | 0.46 | 0.62 | 1.07 | −2.68 | −1.68 | −1.22 | −0.85 | 0.63 | 3.10 | 3.12 | 2.24 | 4.11 |
| 13 | −2.10 | 0.04 | 0.33 | 0.46 | 0.59 | 1.19 | −2.88 | −1.06 | −1.59 | −0.95 | 1.22 | 2.64 | 3.49 | 1.81 | 3.89 |
| 14 | −0.23 | −0.13 | 0.57 | 0.60 | 0.41 | 0.71 | −1.49 | −1.28 | −0.81 | 0.88 | 0.46 | 1.58 | 2.03 | 1.37 | 2.71 |
| 15 | −0.93 | 0.39 | −0.30 | 0.44 | 0.29 | 0.32 | −1.72 | −0.22 | −1.00 | 0.08 | 1.12 | 0.44 | 2.24 | 1.25 | 1.27 |
| 16 | −0.68 | 0.08 | −0.04 | 0.40 | 0.50 | 0.41 | −1.39 | −1.03 | −0.84 | −0.04 | 1.04 | 0.80 | 1.89 | 1.58 | 1.26 |
| 17 | −0.67 | −0.13 | 0.12 | 0.77 | 0.70 | 0.66 | −2.54 | −1.72 | −1.33 | 0.91 | 1.04 | 1.54 | 2.97 | 2.22 | 2.11 |

Once a corrupted neutral point is detected, a method similar to that as described with respect to regular grid points 68 may be used to estimate the missing color data value along the neutral-axis.

At step S206, for the near neutral points, controller 18 determines that a color point is corrupt color data if a difference between the color point and the corresponding reference color point exceeds a threshold.

For example, for each of the near-neutral points, for each selected color point of the plurality of color points, controller 18 determines a difference between the selected color point and a corresponding reference color point of the plurality of reference color points, and determines if the difference exceeds a threshold (S104), wherein the selected color point is determined to be corrupt color data if the difference exceeds the threshold (S106).

Table 7 illustrates the comparison of cartridge 22 color data with reference cartridge data. Note that the shaded data in the table is from the closest neutral point. Similar to the results of neutral point, the near-neutral point color data varies within a small range relative to the near-neutral point reference cartridge data. Based on observation, two sets of thresholds are computed, i.e., T₁₅ for 5-8 and T₁₆ for the rest. If the difference between the particular cartridge 22 and the reference cartridge data at a near-neutral point exceeds the thresholds, then the near-neutral point color data is determined to be corrupt color data.

TABLE 7
Comparisons With Reference Cartridge Data.

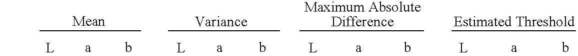

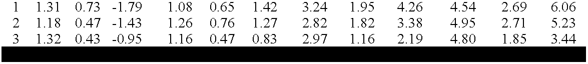

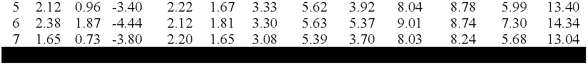

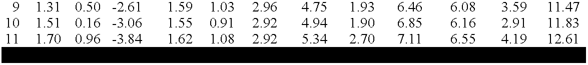

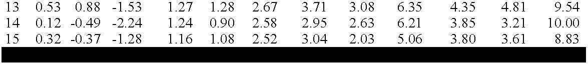

Table 8 illustrates the results of comparing the near-neutral points to their closest corresponding neutral point. The estimated thresholds based on means and variances are similar to those determined for the neutral points. One final threshold may be defined by taking the maximum of the several thresholds. If the difference between the near-neutral point color data and its closest corresponding reference cartridge neutral point color data is greater than the threshold, then the near-neutral color point color data is determined to be corrupt color data.

TABLE 8
Comparisons With Reference Cartridge Nearby Neutral Point Data

| | Mean | | | Variance | | | Minimum Difference | | | Maximum Difference | | | Estimated Threshold | | |
|---|---|---|---|---|---|---|---|---|---|---|---|---|---|---|---|
| | L | a | b | L | a | b | L | a | b | L | a | b | L | a | b |
| 1 | 1.40 | 1.22 | 1.25 | 0.27 | 0.29 | 0.44 | 1.00 | 0.64 | 0.61 | 1.89 | 1.90 | 1.94 | 2.19 | 2.10 | 2.58 |
| 2 | 1.54 | −1.50 | 0.67 | 0.37 | 0.27 | 0.34 | 0.98 | −2.06 | 0.03 | 2.51 | −0.89 | 1.29 | 2.64 | 2.33 | 1.68 |
| 3 | 0.59 | 1.18 | −2.25 | 0.28 | 0.45 | 0.86 | −0.05 | 0.21 | −3.67 | 1.23 | 2.04 | −0.81 | 1.43 | 2.53 | 4.84 |
| 4 | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |
| 5 | 1.78 | 1.90 | 1.32 | 0.39 | 0.43 | 0.50 | 1.10 | 1.03 | 0.53 | 2.43 | 2.63 | 2.65 | 2.96 | 3.17 | 2.83 |
| 6 | 2.05 | −0.84 | 1.02 | 0.39 | 0.44 | 0.52 | 1.41 | −1.85 | 0.33 | 2.70 | −0.23 | 2.30 | 3.24 | 2.16 | 2.58 |
| 7 | 1.34 | 1.67 | −2.11 | 0.36 | 0.35 | 0.49 | 0.75 | 0.86 | −3.10 | 2.21 | 2.40 | −1.33 | 2.42 | 2.73 | 3.57 |
| 8 | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |
| 9 | 1.48 | 1.84 | 1.44 | 0.38 | 0.50 | 0.57 | 0.71 | 0.87 | 0.22 | 2.16 | 2.78 | 2.34 | 2.63 | 3.34 | 3.16 |
| 10 | 1.44 | −2.01 | 0.85 | 0.38 | 0.41 | 0.54 | 0.70 | −2.70 | −0.42 | 2.28 | −1.09 | 2.04 | 2.59 | 3.23 | 2.45 |
| 11 | 0.72 | 1.01 | −2.11 | 0.43 | 0.59 | 0.82 | −0.16 | 0.07 | −3.53 | 1.84 | 2.01 | −0.54 | 2.02 | 2.76 | 4.57 |
| 12 | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |
| 13 | 0.81 | 1.49 | 1.15 | 0.46 | 0.62 | 0.28 | 0.09 | −0.14 | 0.44 | 1.81 | 2.62 | 1.62 | 2.19 | 3.35 | 2.01 |
| 14 | 0.97 | −1.80 | 0.59 | 0.46 | 0.62 | 0.47 | −0.19 | −2.94 | −0.50 | 1.72 | −0.66 | 1.27 | 2.36 | 3.66 | 2.01 |
| 15 | 0.27 | 0.86 | −2.06 | 0.44 | 0.56 | 0.52 | −0.43 | 0.09 | −2.86 | 1.10 | 2.38 | −0.99 | 1.60 | 2.54 | 3.62 |
| 16 | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |

The value of the corrupted near-neutral point color data may be estimated from its closest neutral point or its nearby valid near-neutral point, for example, as follows:
C(x₂)=R(x₂)+C(x₁)−R(x₁),
where x₁ is the closest neutral point or its nearby near-neutral point, x₂ is the corrupted position, R(x) is from the standard cartridge, and C(x) is from current cartridge. One value may be estimated based on each of the nearby near-neutral point or its closest neutral point, with the final value being the average of the values.

While this invention has been described with respect to exemplary embodiments, it will be recognized that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of handling data associated with a cartridge for printing with said cartridge, comprising:
comparing color data associated with a cartridge with reference cartridge data representative of a type of said cartridge to yield a comparison result; and
determining whether any of said color data is corrupt color data based on said comparison result.

2. The method of claim 1, wherein said color data forms a color space that can be divided into at least one of a plurality of constituencies,
wherein said comparing said color data with said reference data is performed individually for each constituency of said at least one of said plurality of constituencies.

3. The method of claim 2, wherein one constituency of said plurality of constituencies is the eight vertices of a color cube defined by said color space.

4. The method of claim 2, wherein one constituency of said plurality of constituencies are neutral points corresponding to a neutral axis of a color cube defined by said color space.

5. The method of claim 2, wherein one constituency of said plurality of constituencies are near-neutral points adjacent to but not lying upon a neutral axis of a color cube defined by said color space.

6. The method of claim 2, wherein one constituency of said plurality of constituencies are regular grid points in a color cube defined by said color space.

7. The method of claim 6, wherein said regular grid points are exclusive of the eight vertices of a color cube defined by said color space, neutral points corresponding to a neutral axis of said color cube, and near-neutral points adjacent to but not lying upon said neutral axis.

8. The method of claim 1, said color data having a plurality of color points and said reference cartridge data having a plurality of reference color points corresponding thereto, wherein said comparing said color data with said reference cartridge data to yield said comparison result includes:
for a selected color point of said plurality of color points, determining a difference between said selected color point and a corresponding reference color point of said plurality of reference color points; and
determining if said difference exceeds a threshold.

9. The method of claim 8, wherein said selected color point is determined to be said corrupt color data if said difference exceeds said threshold.

10. The method of claim 1, said color data having a plurality of color points and said reference cartridge data having a plurality of reference color points corresponding thereto, wherein said comparing said color data with said reference cartridge data to yield said comparison result includes:
determining a trend pertaining to at least two reference color points of said plurality of reference color points; and
determining if a selected color point of said plurality of color points corresponding to one of said at least two reference color points violates said trend.

11. The method of claim 10, wherein said selected color point is determined to be said corrupt color data if said selected color point violates said trend.

12. The method of claim 1, further comprising:
printing a plurality of color patches using said cartridge; and
measuring said plurality of color patches to obtain said color data.

13. The method of claim 12, further comprising:
storing said color data in a memory accessible by an imaging apparatus into which said cartridge is installed,
wherein said imaging apparatus is configured to read said color data from said memory.

14. The method of claim 13, wherein said memory is a cartridge memory associated with said cartridge.

15. The method of claim 1, further comprising:
storing said reference cartridge data in a memory accessible by an imaging apparatus into which said cartridge is installed,
wherein said imaging apparatus is configured to read said reference cartridge data from said memory.

16. The method of claim 1, further comprising correcting said corrupt color data based on corresponding reference cartridge data.

17. An imaging apparatus that handles data associated with a cartridge for printing with said cartridge, comprising:
a print engine configured to operatively receive a cartridge; and
a controller communicatively coupled to said print engine, said controller executing instructions to:
determine whether any color data associated with said cartridge is corrupt color data based on comparing the color data with reference cartridge data representative of a type of said cartridge.

18. A cartridge configured for use with the imaging apparatus of claim 17, comprising:
a colorant; and
a memory storing color data associated with said cartridge, wherein said color data forms a color space.

19. The cartridge of claim 18, wherein said color space is divisible into at least one constituency, wherein the at least one constituency comprises one of:
eight vertices of a color cube defined by said color space;
neutral points corresponding to a neutral axis of said color cube;
near-neutral points adjacent to but not lying upon said neutral axis; and
regular grid points in a color cube defined by said color space.

20. The cartridge of claim 18, said memory also storing reference cartridge data representative of a type of said cartridge.

21. The cartridge of claim 18, wherein said cartridge is one of an ink jet printhead cartridge, an ink tank and an electrophotographic cartridge.
